(19) United States
(12) Patent Application Publication
(10) Pub. No.: US 2016/0132193 A1
(43) Pub. Date: May 12, 2016

(54) CABIN MANAGEMENT SYSTEM USING WEARABLE DISPLAY DEVICE

(71) Applicant: HONEYWELL INTERNATIONAL INC., Morristown, NJ (US)

(72) Inventors: Rekha Anil, Bangalore (IN); Amit Patil, Mumbai (IN); Manjunatha Karunakar, Bangalore (IN); Mohan Rao A, Bangalore (IN)

(73) Assignee: HONEYWELL INTERNATIONAL INC., Morristown, NJ (US)

(21) Appl. No.: 14/539,968

(22) Filed: Nov. 12, 2014

(51) Int. Cl. G06F 3/0482; G06F 1/16; G06F 3/0484; G06F 3/16; G06F 3/0488; B64D 47/00; G06F 3/01

(52) U.S. Cl. CPC G06F 3/0482; B64D 47/00; G06F 1/163; G06F 3/016; G06F 3/167; G06F 3/0488; G06F 3/04847

(57) ABSTRACT

Methods and systems are provided for managing systems of an cabin using a wearable device. In one embodiment, a method comprises: generating display data to display a first user interface on a display of the wearable device; receiving user input data based on a user interacting with an input device of the wearable device; and selectively communicating data based on the user input data to a cabin management module that manages systems of the cabin.

### TECHNICAL FIELD

The present disclosure generally relates to methods and systems for managing operations of a cabin, and more particularly relates to methods and systems for managing operations of a cabin using a wearable display device.

### BACKGROUND

Aircraft cabin systems, such as lighting, temperature, audio and other systems are typically controlled from devices which are fixed at certain locations within the aircraft. In some cases, the cabin systems can be controlled from a portable electronic device such as a tablet or smart phone. In either case, the devices are intrusive in nature as they require frequent movement across the cabin to access the devices and/or they occupy the crew member's attention hands and attention. Such intrusive devices limit the crew member's ability to perform. Cabin systems of other vehicles, such as yachts or buses, include such intrusive devices.

Hence, there is a need for improved systems and methods for managing operations of a cabin. Other desirable features and characteristics will become apparent from the subsequent detailed description and the appended claims, taken in conjunction with the accompanying drawings and the foregoing technical field and background.

### BRIEF SUMMARY

Methods and systems are provided for managing systems of a cabin using a wearable device. In one embodiment, a method comprises: generating display data to display a first user interface on a display of the wearable device; receiving user input data based on a user interacting with an input device of the wearable device; and selectively communicating data based on the user input data to a cabin management module that manages systems of the cabin.

In another embodiment, a system includes a wearable device comprising a display device and at least one input device that accepts user input. The wearable device generates display data to display a first user interface on a display of the wearable device, receives user input data based on a user interacting with the at least one input device of the wearable device, and selectively communicates data based on the user input data to a cabin management module that manages the systems of the cabin.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following figures, wherein like numerals denote like elements, and wherein:

FIG. 1 is a functional block diagram illustrating an aircraft having cabin management system in accordance with exemplary embodiments;

FIG. 2 is dataflow diagram illustrating a cabin management system in accordance with exemplary embodiments;

FIGS. 3-14 are illustrations of user interfaces that may be displayed by the cabin management system in accordance with various embodiments; and

FIG. 15 is a flowchart illustrating a cabin management method that may be performed by the cabin management system in accordance with exemplary embodiments.

### DETAILED DESCRIPTION

The following detailed description is merely exemplary in nature and is not intended to limit the disclosure or the application and uses of the disclosure. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

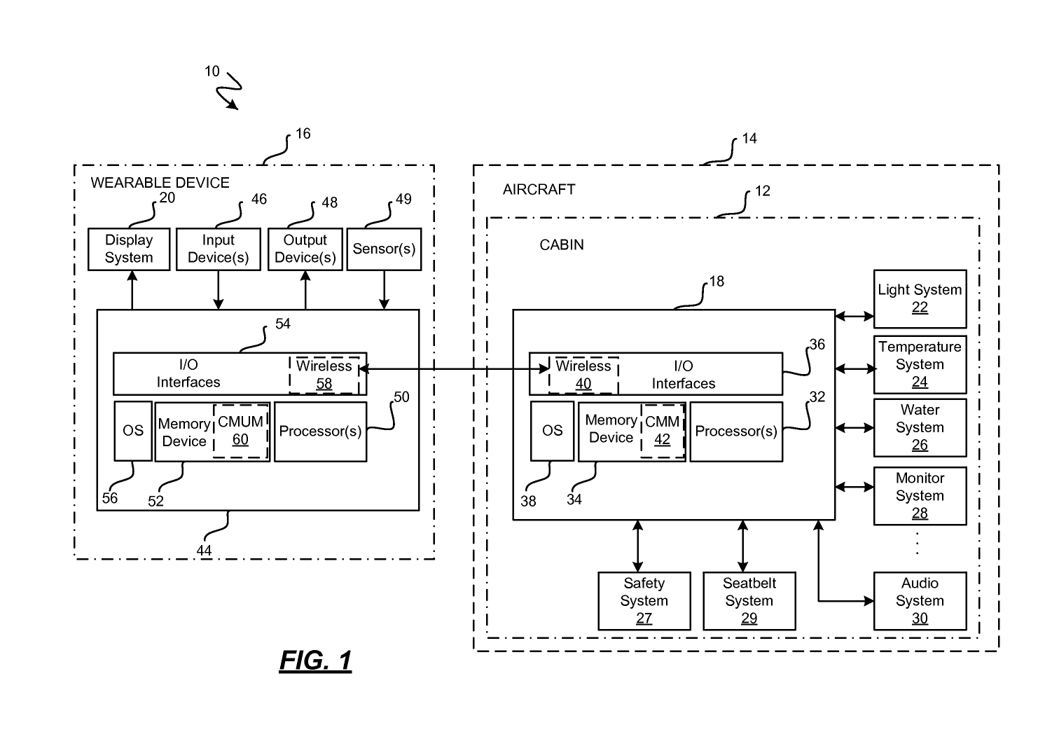

Referring now to FIG. 1, exemplary embodiments of the present disclosure are directed to a cabin management system, shown generally at 10, for managing one or more systems of a cabin 12. In the exemplary embodiments described the cabin 12 is of an aircraft 14. As can be appreciated, cabin management systems 10 of the present disclosure may be implemented in any cabin 12 of any vehicle such as, but not limited to boats, buses, aircraft, etc. and is not limited to any one example. Although the figures shown herein depict an example with certain arrangements of elements, additional intervening elements, devices, features, or components may be present in actual embodiments. It should also be understood that FIG. 1 is merely illustrative and may not be drawn to scale.

The cabin management system 10 generally includes a wearable device 16 that wirelessly communicates with a computing system 18 of the aircraft 14. The wearable device 16 may be any device that is wearable by a user such as, but not limited to, eyeglasses, a watch, a bracelet, a ring, a headband, footwear, clothes, contact lenses, etc. In the exemplary embodiments discussed herein, the wearable device 16 includes eyeglasses that are wearable by a user and that include an integrated display system 20.

The wearable device 16 communicates with the computing system 18 to control the systems of the cabin 12 and/or to receive information about the systems of the cabin 12. The wearable device 16 communicates with the computing system 18 based on input received from the user wearing the wearable device 16. In various embodiments, the systems to be controlled and/or to provide information include, but are not limited to, a cabin lighting system 22, a cabin temperature system 24, a water supply system 26, a safety system 27, a video system 28, a seatbelt system 29, and an audio system 30. As can be appreciated, the systems to be controlled and/or to provide information may vary depending on the vehicle that implements the cabin management system 10.

The computing system 18 of the aircraft 14 generally includes processing hardware, such as a processor 32, a memory device 34, input/output interfaces 36 and the like, that are managed and accessed by a suitable operating system 38. The processor 32 may include one or more of microprocessors, microcontrollers, processing cores and/or other computing resources spread across any number of distributed or integrated systems. The memory device 34 may include any non-transitory short or long term storage capable of storing programming instructions for execution on the processor 32, such as, but not limited to, random access memory (RAM), read only memory (ROM), flash memory, magnetic or optical mass storage, and/or the like.

The input/output interfaces 36 may include software and/or hardware for communicating with networks (e.g., local area networks, wide area networks, or other networks), for communicating with peripheral devices (not shown) associated with the computing system 18 (e.g., mouse, keyboard, touchscreen, display, etc.), for communicating the systems 22-30 of the cabin 12, and for communicating with the wearable device 16. In particular, the input/output interfaces 36 include a wireless interface 40 for wirelessly communicating data to and wirelessly receiving data from the wearable device 16 according to a wireless communication protocol. In various embodiments, the wireless interface 40 communicates directly with the wearable device 16 according to the wireless communication protocol. In various other embodiments, the wireless interface 40 communicates with a wireless access point (not shown) that is associated with the computing system 18 and the wireless access point communicates with the wearable device 16 according to the wireless communication protocol. In such embodiments, the wireless interface 40 communicates with the wireless access point according to a wired or a wireless protocol.

In various embodiments, the memory device 34 includes a cabin management module (CMM) 42. The CMM 42 contains instructions that, when executed by the processor 32, control one or more features of the systems 22-30 and/or receives information about one or more features of the systems 22-30 (via the input/output interfaces 36). The CMM 42 controls the features of the systems 22-30 and/or receives information about the features based on data received from the wearable device 16. The CMM 42 provides data to the wearable device 16 based on the controlling and the monitoring of the systems 22-30 of the cabin 12 (via the wireless interface 40).

The wearable device 16 includes a computing system 44, one or more input devices 46, one or more output devices 48, one or more sensors 49, and the display system 20. The input devices 46 can include, but are not limited to a touch pad, one or more depressible buttons, one or more switches, a recording device, and/or any other type of device capable of accepting and interpreting user input. The output devices 48 can include, but are not limited to, an audio device, a haptic device, and/or any other type of device for presenting information and/or notifications to a user. The sensors 49 include sensors for detecting turbulence on the aircraft such as, but not limited to, a gyroscope. The display system 20 includes a display device and a projection device that displays content on the display device based on information received from the computing system 44. In the case of the wearable device 16 being eyeglasses, the display device is a lens or display piece in front of a lens of the eyeglasses.

The computing system 44 of the wearable device 16 generally includes processing hardware, such as a processor 50, a memory device 52, input/output interfaces 54 and the like, that are managed and accessed by a suitable operating system 56. The processor 50 may include one or more of microprocessors, microcontrollers, processing cores and/or other computing resources spread across any number of distributed or integrated systems. The memory device 52 may include any non-transitory short or long term storage capable of storing programming instructions for execution on the processor 50, such as, but not limited to, random access memory (RAM), read only memory (ROM), flash memory, magnetic or optical mass storage, and/or the like.

The input/output interfaces 54 may include software and/or hardware for communicating with the display system 20, for communicating with the input devices 46, for communicating with the output devices 48, and for communicating with the computing system 18 of the aircraft 14. In particular, the input/output interfaces 54 include a wireless interface 58 for wirelessly communicating data to and wirelessly receiving data from the computing system 18 of the aircraft 14 according to a wireless communication protocol. In various embodiments, the wireless interface 58 communicates directly with the computing system 18 according to the wireless communication protocol. In various other embodiments, the wireless interface 58 communicates with a wireless access point (not shown) that is associated with the computing system 18 and the wireless access point communicates with the computing system 18. In such embodiments, the wireless access point communicates with the computing system 18 according to a wired or a wireless protocol.

In various embodiments, the memory device 52 includes a cabin user management module (CMUM) 60. The CMUM 60 contains instructions that, when executed by the processor 50, cause data to be sent to the computing system 18 of the aircraft 14 and to be received from the computing system 18 of the aircraft 14. The CMUM 60 causes data to be sent or received based on input received from a user of the wearable device 16. In particular, the CMUM 60 provides information about the systems 22-30 to the user visually through the display system 20 and allows the user to select and control features of the systems 22-30 via the input devices 46 based on the information that is being displayed.

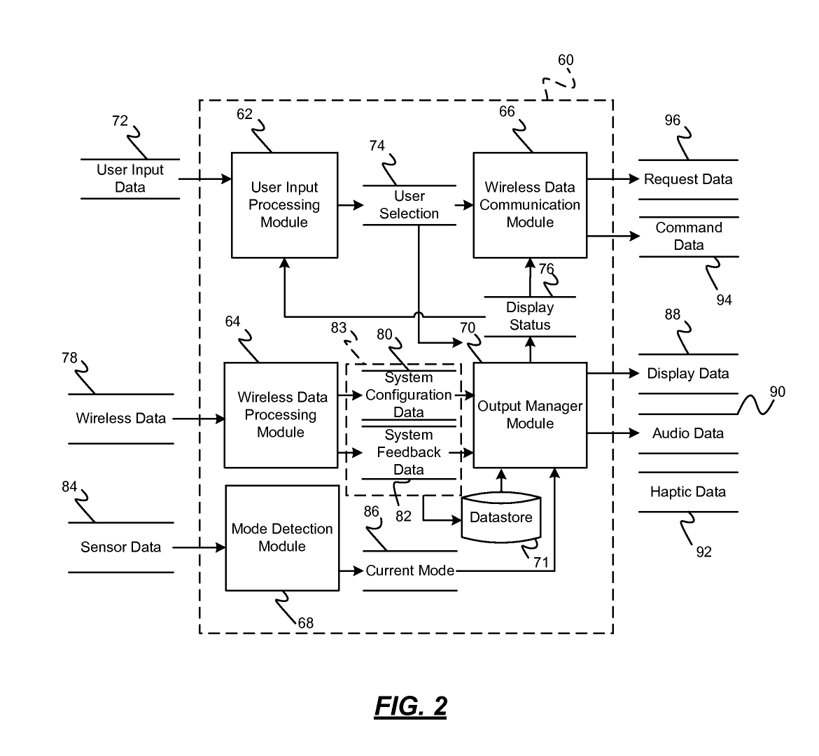

Referring now to FIG. 2 and with continued reference to FIG. 1, a dataflow diagram illustrates various embodiments of the CMUM 60 in greater detail. Various embodiments of CMUM 60 according to the present disclosure may include any number of sub-modules embedded within the CMUM 60. As can be appreciated, the sub-modules shown in FIG. 2 may be combined and/or further partitioned to similarly allow a user to manage the cabin systems 22-30 through the wearable device 16. Inputs to the CMUM 60 may be received from other modules in the computing system 44, from the input devices 46, or from other sub-modules (not shown) within the CMUM 60. In various embodiments, the CMUM 60 includes a user input processing module 62, a wireless data processing module 64, a wireless data communication module 66, a mode detection module 68, an output manager module 70, and a datastore 71.

The user input processing module 62 receives as input user input data 72. The user input data 72 may be generated based on a user's interaction with one or more of the input devices 46. For example, the user input data 72 can include speech recorded by the recording device, or be based on position or activation signals generated by the touch pad, the depressible buttons and/or the switches.

The user input processing module 62 processes the user input data 72 to determine a user selection 74. In particular, the user input processing module 62 receives a display status 76 from the output manager module 70. The display status 76 indicates a current interface that is being displayed. The user input processing module 62 determines available options given the current interface, and processes the user input data 72 to determine the user selection 74 of one or more of the options. For example, if the user input data 72 includes speech data, the user input processing module 62 performs speech recognition methods on the speech data and identifies the user selection 74 by matching the recognized speech to one of the options. In another example, if the user input data includes touch pad data, the user input processing module 62 processes the touch pad data to determine selected coordinates on the user interface and matching the selected coordinates to one of the options displayed at the coordinates. As can be appreciated, other methods of processing user input are contemplated and thus, the user input processing module 62 is not limited to the present examples.

The wireless data processing module 64 receives as input wireless data 78. The wireless data 78 is communicated to the CMUM 60 by the CMM 42. The wireless data processing module 64 processes the wireless data 78 to determine system configuration data 80 and/or system feedback data 82. For example, the CMM 42 transmits wireless data 78 including system configuration data 80 for a particular system 22-30 of the cabin 12 in response to a request, and the wireless data processing module 64 processes the wireless data 78 to determine the system configuration data 80. The system configuration data 80 includes information about a current configuration or status of the system 22-30, and/or commands available for changing the current configuration. In another example, the CMM 42 transmits wireless data 78 including system feedback data 82 in response to an issued command to change, and the wireless data processing module 78 processes the wireless data 78 to determine the system feedback data 82. The system feedback data 82 includes information indicating the system configuration has changed or has not changed.

In various embodiments, the wireless data processing module 64 stores the processed data 83 in the datastore 71. In such embodiments, if the CMM 42 were to become offline and unable to communicate, the already received configuration data 80 and/or system feedback data 72 may be retrieved from the datastore 71 and used.

The mode detection module 68 receives as input sensor data 84. The sensor data 84 may be generated by one or more of the input devices 46. Based on the sensor data 84, the mode detection module 68 determines a current mode. In various embodiments, the current mode can be one of a default mode, and a turbulence mode. For example, the mode detection module 68 determines the current mode 86 to be the turbulence mode when the sensor data 84 indicates some level of vibration. The mode detection module 68 determines the current mode 86 to be the default mode when the turbulence mode is not determined.

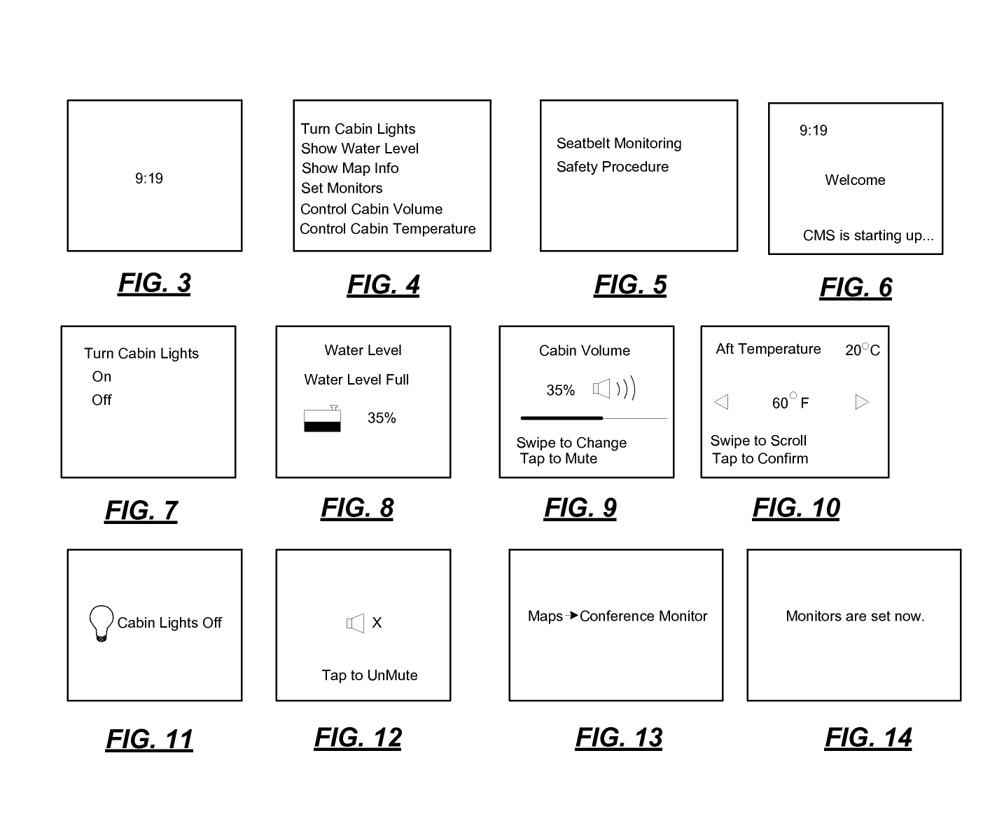

The output manager module 70 receives as input the user selection 74, the system configuration data 80, the current mode 86, and/or the system feedback data 82. The output manager module 70 manages the output to the user provided by the display system 20 and/or the output devices 48 based on the inputs. In various embodiments, the output manager module 70 generates display data 88 for use by the display system 20 to display a user interface based on the user selection 74 and the current mode 86. As shown in FIG. 3-14, the user interface may be selected from one of many user interfaces that include, but are not limited to, a default interface shown in FIG. 3, a menu interface shown in FIG. 4, a turbulence menu interface shown in FIG. 5, a CMM startup interface shown in FIG. 6, one or more system interfaces shown in FIGS. 7-10, one or more feature status interfaces shown in FIG. 11-14. In various embodiments, the output manager module 70 generates display data 88 that incorporates the system configuration data 80 and/or the system feedback data 82 into the user interface, as shown in FIGS. 4-14.

With reference back to FIGS. 2 and 1, in various embodiments, the output manager module 70 generates audio data 90 and/or haptic data 92 for use by the output devices 48 to notify the user of system options indicated by the system configuration data 80, to notify the user of the identified user selection 74, and/or to notify the user of the system feedback data 82. The audio data 90 may include speech data and/or may include activation data for activating a certain audio tone or frequency. The haptic data 92 may include activation data for activating a certain haptic device with a certain intensity or frequency.

The wireless data communication module 66 receives as input the user selection 74 and the display status 76. Based on the user selection 74, the wireless data communication module 66 generates command data 94 or request data 96 for wirelessly communicating to the CMM 42 (via the wireless interface 58). The command data 94 includes a command for controlling the selected option (e.g., turn lights on, turn lights off, set temperature to X degrees, turn volume up, turn volume down, etc.) The request data 96 includes a request for information about a particular system and/or a request for confirmation that the CMM 42 is running.

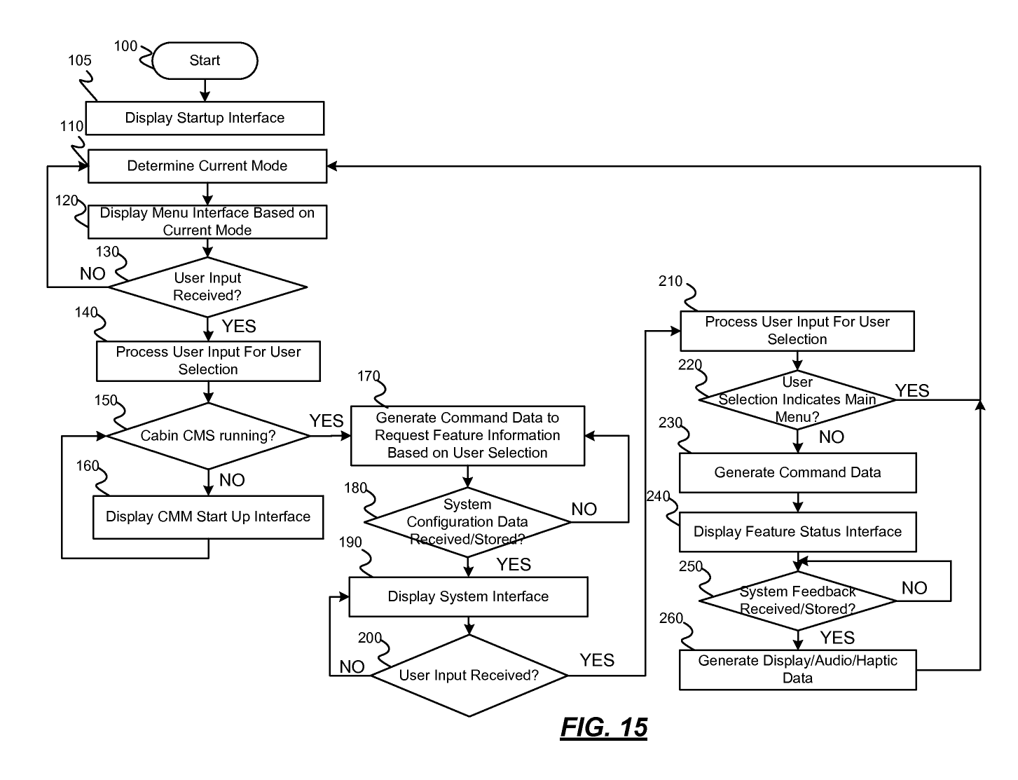

Referring now to FIG. 15, and with continued reference to FIGS. 1-14, a flowchart illustrates a method that can be performed by the CMUM 60 in accordance with the present disclosure. As can be appreciated in light of the disclosure, the order of operation within the method is not limited to the sequential execution as illustrated in FIG. 15, but may be performed in one or more varying orders as applicable and in accordance with the present disclosure. As can further be appreciated, one or more steps may be added or removed from the method shown in FIG. 15, without altering the spirit of the method.

In various embodiments, the method can be scheduled to run based on predetermined events, and/or can run continually during operation of the wearable device 16.

The method may begin at 100. The output manager module 70 displays the default interface (FIG. 3) at 110. The mode detection module 68 determines the current mode 86 at 105. Either automatically or in response to a user selection, the output manager module 70 displays the menu interface (FIG. 4 or 5) based on the current mode 86 at 120. The output manager module 70 displays the menu interface (FIG. 4 or 5) until user input data 72 is received. When user input data 72 is received at 130, the user input processing module 62 processes the user input data 72 to determine the user selection 74 at 140. It is determined whether the CMM 42 is running at 150. If the CMM 42 is not running at 150, the output manager module 70 displays the CMM startup interface (FIG. 6) at 160 until system feedback data 82 indicates that the CMM 42 is running.

Once the CMM 42 is running at 150, the wireless data communication module 66 generates the request data 96 to request system information based on the user selection 74 at 170. In return, the CMM 42 receives the request data 96 and generates system configuration data 80 including the system information. Once the wireless data processing module 64 receives (and stores) the system configuration data 80 including the system information at 180, the output manager module 70 displays the system interface (FIGS. 7-10) using the system configuration data 80 at 190.

If user input data 72 is not received at 200, the output manager module 70 continues to display the system interface (FIGS. 7-10) at 190. If, however, user input data 72 is received at 200, the user input processing module 62 processes the user input data to determine the user selection 74 at 210. If the user selection 74 indicates a main menu selection at 220, the method continues with the mode detection module 68 determining the current mode 86 at 110 and the output manager module 62 displaying the menu interface (FIG. 4 or 5) at 120. If, however, the user selection 74 does not indicate a main menu selection rather, indicates a system feature selection at 220, the wireless data communication module 66 generates the command data 94 to control the feature of the system 22-30 based on the user selection 74 at 230. The output manager module 70 displays the feature status interface (FIGS. 11-14) at 240. Once the wireless data processing module 64 receives (and stores) the system feedback data 82 including an indication of whether the system feature was changed or was not changed at 250, the output manager module 70 generates at least one of the audio data 90, the haptic data 92, and the display data 88 to notify the user of the feedback (i.e., whether the feature has been changed or not changed) at 260. Thereafter, the method continues with the mode detection module 68 determining the current mode 86 at 110 and the output manager module 70 displaying the menu interface (FIG. 4 or 5) at 120.

Those of skill in the art will appreciate that the various illustrative logical blocks, modules, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for managing systems of a cabin using a wearable device, comprising:
generating display data to display a first user interface on a display of the wearable device;
receiving user input data based on a user interacting with an input device of the wearable device; and
selectively communicating data based on the user input data to a cabin management module that manages systems of the cabin.

2. The method of claim 1 wherein the first user interface comprises a menu interface that lists the systems of the cabin.

3. The method of claim 1 wherein the first user interface comprises control options associated with a system of the cabin.

4. The method of claim 1 wherein the selectively communicating data comprises selectively communicating command data that commands a feature of a system of the cabin.

5. The method of claim 1 wherein the selectively communicating data comprises selectively communicating a request for configuration data associated with a system of the cabin.

6. The method of claim 1 further comprising receiving system configuration data from the cabin management module.

7. The method of claim 6 further comprising generating display data to display a second user interface on the display of the wearable device based on the system configuration data.

8. The method of claim 1 further comprising receiving system feedback data from the cabin management module.

9. The method of claim 8 further comprising generating display data to display a second user interface on the display based on the system feedback data.

10. The method of claim 8 further comprising generating audio data to cause an audio device to generate an audio notification based on the system feedback data.

11. The method of claim 8 further comprising generating haptic data to cause a haptic device to generate a haptic notification based on the system feedback data.

12. The method of claim 1 further comprising:
determining an operating mode based on sensor data, and
wherein the generating the display data to display the first user interface is based on the operating mode.

13. The method of claim 1 wherein the operating mode is at least one of a default mode and a turbulence mode.

14. The method of claim 1 wherein the systems of the cabin of the comprise at least two of a lighting system, an audio system, a temperature system, a water system, and a monitor system.

15. The method of claim 1 wherein the wearable device is at least one of eyeglasses, a watch, a bracelet, a ring, a headband, footwear, clothes, and contact lenses.

16. A system for managing systems of a cabin, comprising:
a wearable device comprising a display device and at least one input device that accepts user input,
wherein the wearable device generates display data to display a first user interface on a display of the wearable device, receives user input data based on a user interacting with the at least one input device of the wearable device, and selectively communicates data based on the user input data to a cabin management module that manages the systems of the cabin.

17. The system of claim 16 wherein the at least on input device comprises a touch sensor.

18. The system of claim 16 wherein the at least one input device comprises a recording device.

19. The system of claim 16 wherein the wearable device is at least one of eyeglasses, a watch, a bracelet, a ring, a headband, footwear, clothes, and contact lenses.

20. The method of claim 1 wherein the systems of the cabin of the comprise at least two of a lighting system, an audio system, a temperature system, a water system, and a monitor system.
